(19) United States
(12) Patent Application Publication
(10) Pub. No.: US 2025/0196670 A1
(43) Pub. Date: Jun. 19, 2025

(54) VEHICLE CHARGING SYSTEM

(71) Applicant: LG ELECTRONICS INC., Seoul (KR)

(72) Inventors: Jiho LEE, Seoul (KR); Hoon HUR, Seoul (KR); Kangsuk LEE, Seoul (KR); Heemin YUN, Seoul (KR); Byungsoo AN, Seoul (KR)

(73) Assignee: LG ELECTRONICS INC., Seoul (KR)

(21) Appl. No.: 18/842,595

(22) PCT Filed: Aug. 10, 2022
(86) PCT No.: PCT/KR2022/011930

§ 371 Date: Aug. 29, 2024

(51) Int. Cl. B60L 53/16; B60L 53/18; B60L 53/302

(52) U.S. Cl. CPC B60L 53/16; B60L 53/18; B60L 53/302

(57) ABSTRACT

An embodiment may comprise: a plurality of cables; an inner jacket in which an inner flow path is formed, wherein the plurality of cables pass through the inner flow path; an outer jacket in which an outer flow path is formed and which surrounds the outer circumference of the inner jacket; a porous material disposed in at least one of the inner flow path or the outer flow path; and a cooler which cools a cooling fluid that has passed through one of the inner flow path or the outer flow path, and then supplies the cooling fluid to the other of the inner flow path or the outer flow path.

### TECHNICAL FIELD

The present invention relates to a charging system for a vehicle.

### BACKGROUND ART

The development of electric vehicles has created in increase of needs for charging devices that transmits power.

The higher current in any conductor, the more heat is generated. As a result, the conductor between the charging device and the vehicle has become larger in size to accommodate higher introduction current.

An example of a charging system capable of charging an electric vehicle comprises a charging system for an electric vehicle, which is disclosed in Korea Patent Publication No. 10-1952159 B1 (announced on Feb. 26, 2019). The charging system for the electric vehicle comprises: a power supply device; a cable provided with a first end and a second end, wherein the first terminal is attached to the power supply device, and the cable comprises a charging conductor and a cooling pipe, which extend from the first end and the second end, respectively; and a connector attached to the second end of the cable and provided with a form factor corresponding to a charging port of the electric vehicle.

### DISCLOSURE OF THE INVENTION

### Technical Problem

This embodiment provides a vehicle charging system, in which heat generated from a cable is transferred to a cooling fluid passing through a dual cooling flow path to effectively dissipate the heat of the cable.

This embodiment provides a vehicle charging system, in which a plurality of cables are supported to be spaced apart from each other, thereby effectively dissipating heat of each of the plurality of cables.

### Technical Solution

In this embodiment, a vehicle charging system comprises: a plurality of cables; an inner jacket in which an inner flow path is provided, wherein the plurality of cables pass through the inner flow path; an outer jacket in which an outer flow path is provided and which is configured to surround an outer circumference of the inner jacket; a porous material disposed in at least one of the inner flow path or the outer flow path; and a cooler configured to cool a cooling fluid passing through one of the inner flow path and the outer flow path and supplies the cooling fluid to the other of the inner flow path and the outer flow path.

The porous material may comprise an inner porous material disposed between the plurality of cables and the inner jacket and configured to support the plurality of cables to be spaced apart from each other.

The porous material may comprise an outer porous material disposed between the inner jacket and the outer jacket.

The porous material may comprise metallic foam having porosity of 10% to 90%.

The porous material may comprise metallic foam having thermal conductivity of 25 W/m·K to 35 W/m·K.

The vehicle charging system may further comprise a power supply, to which one end of each of the plurality of cables is connected, and a connector, to which the other end of each of the plurality of cables is connected.

The cooler may be disposed inside the power supply.

The cooler may comprise: a first channel configured to guide the cooling fluid passing through one of the inner flow path and the outer flow path; a cooling unit connected to the first channel to cool the cooling fluid guided to the first channel; and a second channel configured to guide the cooling fluid cooled by the cooling unit to the other of the inner flow path and the outer flow path.

The outer jacket may comprise an outer through-hole that is closer to one end of the one end and the other end thereof.

The inner jacket may comprise an inner through-hole that is closer to the other end of one end and the other end thereof.

The inner through-hole may be provided in plurality.

The plurality of inner through-holes may be arranged in a line in a longitudinal direction of the inner jacket.

The plurality of inner through-holes may be spaced apart from each other in a circumferential direction of the inner jacket.

The cooler may comprise a thermoelectric element having a cooling body configured to cool the cooling fluid.

The cooler may comprise a compressor, a condenser, an expander, and an evaporator, through which the cooling fluid sequentially passes.

### Advantageous Effects

According to this embodiment, the cooling fluid cooled by the cooler may pass through one of the inner flow path and the outer flow path and then pass through the other of the inner flow path and the outer flow path, thereby effectively dissipating the heat from the plurality of cables accommodated in the inner flow path.

In addition, the porous material may support the plurality of cables, and the plurality of cables may be maintained to be spaced apart from each other as well as be maintained to be spaced apart from the inner jacket so that the outer circumference of each of the plurality of cables is heat-exchanged with the cooling fluid, thereby effectively dissipating the heat of the plurality of cables through the cooling fluid.

### BRIEF DESCRIPTION OF THE DRAWINGS

FIG. 1 is a view illustrating an example of a vehicle charging system according to this embodiment,

FIG. 2 is a view of a porous material according to this embodiment,

FIG. 3 is an enlarged view illustrating an example of the vehicle charging system according to this embodiment,

FIG. 4 is a cross-sectional view illustrating the inside of an outer jacket as an example of the vehicle charging system according to this embodiment,

FIG. 5 is an enlarged view illustrating a flow of a cooling fluid inside the outer jacket as an example of the vehicle charging system according to this embodiment,

FIG. 6 is a cutaway view illustrating the flow of the cooling fluid as an example of the vehicle charging system according to this embodiment,

FIG. 7 is an enlarged view illustrating a flow of a cooling fluid inside an outer jacket as another example of the vehicle charging system according to this embodiment,

FIG. 8 is a cutaway view illustrating the flow of the cooling fluid as another example of the vehicle charging system according to this embodiment, and

FIG. 9 is a view illustrating a flow of a refrigerant as further another example of the vehicle charging system according to this embodiment.

### MODE FOR CARRYING OUT THE INVENTION

Hereinafter, detailed embodiments will be described in detail with reference to the accompanying drawings.

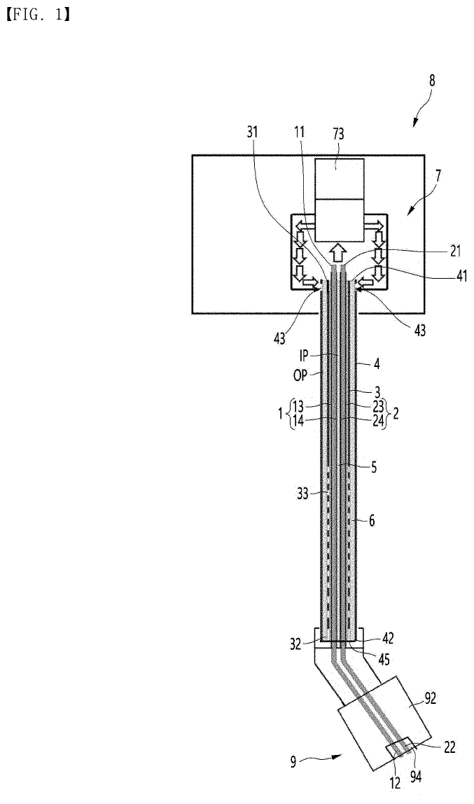

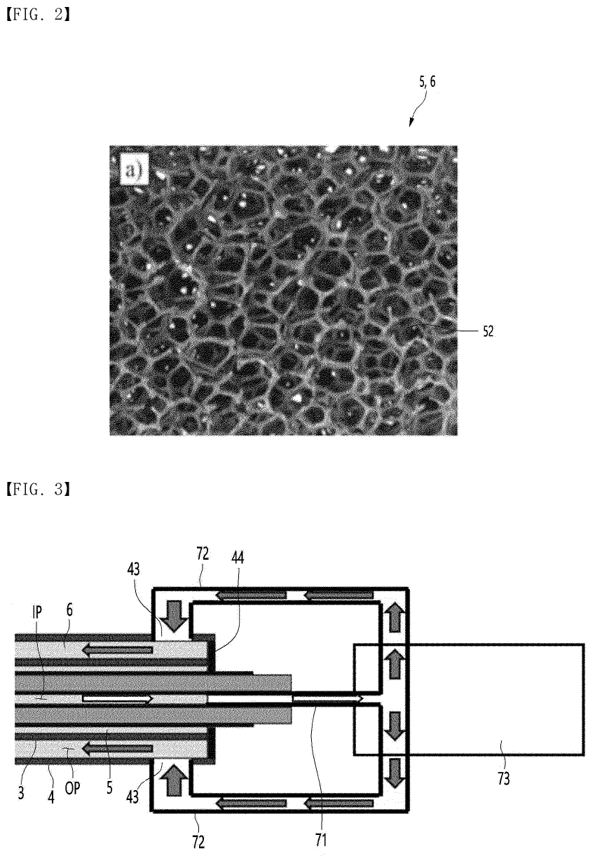

FIG. 1 is a view illustrating an example of a vehicle charging system according to this embodiment, FIG. 2 is a view of a porous material according to this embodiment, and FIG. 3 is an enlarged view illustrating an example of the vehicle charging system according to this embodiment.

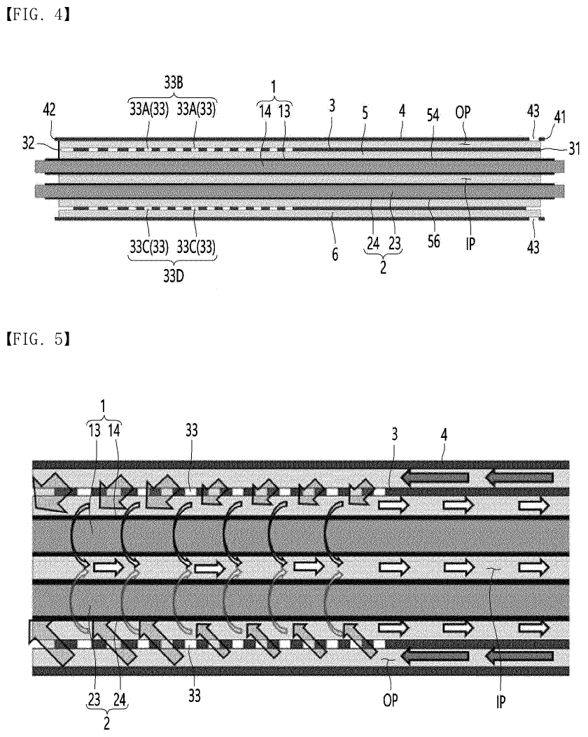

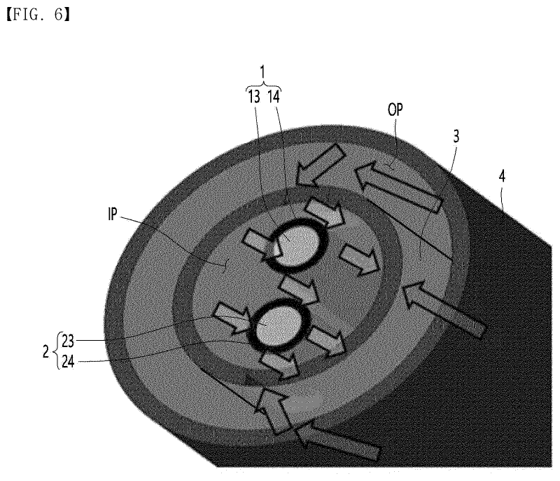

FIG. 4 is a cross-sectional view illustrating the inside of an outer jacket as an example of the vehicle charging system according to this embodiment, FIG. 5 is an enlarged view illustrating a flow of a cooling fluid inside the outer jacket as an example of the vehicle charging system according to this embodiment, and FIG. 6 is a cutaway view illustrating the flow of the cooling fluid as an example of the vehicle charging system according to this embodiment.

An example of a vehicle charging system may comprise a plurality of cables 1 and 2, an inner jacket 3, an outer jacket 4, porous materials 5 and 6, and a cooler 7. The example of the vehicle charging system may further comprise a power supply 8 and a connector 9.

Each of the plurality of cables 1 and 2 may comprise a conductor and an insulator surrounding the conductor. The insulator may be spaced apart from the inner jacket 3 in a radial direction.

The plurality of cables 1 and 2 may comprise a pair of cables 1 and 2. Each of the pair of cables 1 and 2 may be connected to the power supply 8 and the connector 9.

In the pair of cables 1 and 2, the first cable 1 may comprise one end 11 and the other end 12. Here, the one end 11 may be connected to the power supply 8, and the other end 12 may be connected to the connector 9.

The first cable 1 may comprise a first conductor 13 and a first insulator 14 surrounding the first conductor 13. The first insulator 14 may be spaced apart from the inner jacket 3 in the radial direction.

In the pair of cables 1 and 2, the second cable 2 may comprise one end 21 and the other end 22. Here, the one end 21 may be connected to the power supply 8, and the other end 22 may be connected to the connector 9.

The second cable 2 may comprise a second conductor 23 and a second insulator 24 surrounding the second conductor 23. The second insulator 24 may be spaced apart from the inner jacket 3 in the radial direction.

The plurality of cables 1 and 2 may pass through the inner jacket 3. A length of each of the pair of cables 1 and 2 may be greater than that of each of the inner jacket 3 and the outer jacket 4.

The one end 11 and the other end 12 of the first cable 1 may be disposed outside the outer jacket 4, and a portion between the one end 11 and the other end 12 of the first cable 1 may be disposed inside the inner jacket 3. The portion between the one end 11 and the other end 12 of the first cable 1 may be a portion to be cooled by a cooling fluid.

The one end 21 and the other end 22 of the first cable 2 may be disposed outside the outer jacket 4, and a portion between the one end 21 and the other end 22 of the second cable 2 may be disposed inside the inner jacket 3. The portion between the one end 21 and the other end 22 of the second cable 2 may be a portion to be cooled by the cooling fluid.

An inner flow path IP may be provided in the inner jacket 3. The inner flow path IP may be provided inside the inner jacket 3. The plurality of cables 1 and 2 may pass through the inner flow path IP. The cooling fluid may flow through the inner flow path IP, and the cooling fluid may cool the plurality of cables 1 and 1 together while passing through the inner flow path IP.

The inner jacket 3 may comprise an inner through-hole 33 that is closer to the other end 32 of the one end 31 and the other end 32.

The one end 31 of the inner jacket 3 may be closer to the power supply 8 of the power supply 8 and the connector 9, and the other end 32 of the inner jacket 3 may be closer to the connector 9 of the power supply 8 and the connector 9.

The cooling fluid may flow into the inner flow path IP through the inner through-hole 33 or may be discharged to the inner flow path IP through the inner through-hole 33.

The cooling fluid may flow in a longitudinal direction of the inner flow path IP.

The inner through-hole 33 may be provided in plurality, and the plurality of inner through-holes 33 may be arranged in a line in the longitudinal direction of the inner jacket 3. A plurality of inner through-holes 33 may be provided to be spaced apart from each other in a circumferential direction of the inner jacket.

As illustrated in FIG. 4, the plurality of inner through-holes 33 may comprise a first through-hole group 33B including a plurality of first through-holes 33A defined to be spaced apart from each other in the longitudinal direction of the inner jacket 3 and a second through-hole group 33D including a plurality of through-hole 33C spaced apart from the first through-hole group 33B in the circumferential direction of the inner jacket 3 and defined to be spaced apart from each other in the longitudinal direction of the inner jacket 3.

An outer flow path OP may be provided in the outer jacket 4. The outer flow path OP may be provided inside the outer jacket 4. The outer flow path OP may be provided between the inner jacket 3 and the outer jacket 4. The outer jacket 4 may surround an outer circumference of the inner jacket 3. An inner diameter of the outer jacket 4 may be greater than an outer diameter of the inner jacket 3.

The outer jacket 4 may comprise an outer through-hole 43 that is closer to one end 41 of the one end 41 and the other end 42. The outer through-hole 43 may be provided in plurality. The plurality of outer through-holes 43 may be spaced apart from each other in the circumferential direction.

The one end 41 of the outer jacket 4 may be closer to the power supply 8 of the power supply 8 and the connector 9, and the other end 42 of the outer jacket 4 may be closer to the connector 9 of the power supply 8 and the connector 9.

As illustrated in FIG. 3, one end cover 44 may be provided on the one end 41 of the outer jacket 4 to block the one end of the outer flow path OU and the one end of the inner flow path IP.

As illustrated in FIG. 1, the other end cover 45 may be provided on the other end 42 of the outer jacket 4 to block the other end of the outer flow path OU and the other end of the inner flow path IP.

The porous materials 5 and 6 may be disposed in at least one of the inner flow path IP or the outer flow path OT. The plurality of through-holes 52 (see FIG. 2) through which the cooling fluid passes may be defined in the porous materials 5 and 6.

The porous material 5 and 6 may comprise an inner porous material 5, and the inner porous material 5 may be disposed between the plurality of cables 1 and 2 to support the plurality of cables 1 and 2 to be spaced apart from each other. The inner porous material 5 may support the plurality of cables 1 and 2 so that the cables 1 and 2 are spaced apart from the inner circumference of the inner jacket 3.

A cable hole through which the plurality of cables 1 and 2 pass may be defined in the inner porous material 5. As illustrated in FIG. 4, a first cable hole 54 through which the first cable 1 passes may be defined in the inner porous material 5. As illustrated in FIG. 4, a third cable hole 56 through which the second cable 3 passes may be defined in the inner porous material 5.

Each of the first cable hole 54 and the second cable hole 56 may be defined larger than the through-hole 52 through which the cooling fluid passes.

The porous materials 5 and 6 may comprise an outer porous material 6, and the outer porous material 6 may be disposed between the inner jacket 3 and the outer jacket 4.

The outer porous material 6 may support the outer jacket 4 to be spaced apart from the inner jacket 3, and the outer flow path OP may be maintained without being blocked by the outer porous material 6.

The outer porous material 6 may have an overall hollow cylindrical shape. An inner diameter of the outer porous material 6 may be larger than an outer diameter of the inner porous material 5.

The porous material 5 and 6 may comprise metallic foam having porosity of 10% to 90%.

The porous material 5 and 6 may comprise metallic foam having thermal conductivity of 25 W/m·K to 35 W/m·K.

The cooler 7 may cool the cooling fluid passing through one of the inner flow path IP and the outer flow path OP to supply the cooling fluid to the other of the inner flow path IP and the outer flow path OP.

The cooler 7 may be disposed inside the power supply 8. The cooler 7 may be protected by the power supply 8.

The cooler 7 may comprise a first channel 71, a second channel 72, and a cooling unit 73.

The first channel 71 may guide the cooling fluid passing through either the inner flow path IP or the outer flow path OP. The first channel 71 may be a connection channel connected to the cooling unit 73.

The second channel 72 may guide the cooling fluid cooled by the cooling unit 73 to one of the inner flow path IP and the outer flow path OP. The second channel 72 may be a connection channel connected to the cooling unit 73.

The first channel 71 may be provided with a return flow path (or collection flow path) that guides the cooling fluid passing through either the inner flow path IP or the outer flow path OP to the cooling unit 72.

The second channel 72 may be provided with a supply flow path that supplies the cooling fluid to one of the inner flow path IP and the outer flow path OP.

The cooling unit 73 may be connected to the first channel 71 to cool the cooling fluid passing through the first channel 71. The cooling unit 73 may be connected to the second channel 72 to supply the cooled fluid to the second channel 72.

For example, as illustrated in FIG. 3, when the first channel 71 is connected to the inner flow path IP, and the second channel 72 is connected to the outer flow path OP, the first channel 71 may be connected to the through-hole defined in the one end cover 44. The second channel 72 may be connected to the outer through-hole 43 of the outer tube 4.

The cooling fluid may pass through the outer flow path OP and then pass through the inner flow path IP. Thereafter, after passing through the first channel 71, the cooling fluid may be cooled by the cooling unit 73, and the cooling fluid cooled by the cooling unit 73 may pass through the second channel 72 to flow into the outer flow path OP. The cooling fluid may be circulated through the cooling unit 73, the second channel 72, the outer flow path OP, the inner flow path IP, and the first channel 71.

The cooling fluid cooled by the cooler 7 may first cool the outer flow path OP and then cool the inner flow path IP.

An example of the cooler 7 may comprise a cooling unit such as a thermoelectric element or a refrigeration cycle.

When the cooler 7 is the thermoelectric element, the thermoelectric element may comprise a cooling body that cools the cooling fluid.

When the cooler 7 is the refrigeration cycle, the refrigeration cycle may comprise a compressor, a condenser, an expander, and an evaporator.

An example of the cooling fluid may be air, a coolant such as automobile antifreeze, glycerin, or a refrigerant such as refrigerant freon, ammonia, or hydrocarbon.

When the cooling fluid is the air, the cooler 7 may comprise a radiator (heat dissipation unit) capable of cooling the air and also comprise a fan that supplies the air to the second channel 72 by the cooling unit 73 or a fan that supplies the air of the first channel 71 to the cooling unit 73, and the cooler may be an air-cooled cooler.

When the cooling fluid is the coolant such as automobile antifreeze or glycerin, the cooler 7 may comprise a radiator (heat dissipation unit) capable of cooling the coolant and also comprise a pump that supplies the coolant to the second channel 72 by the cooling unit 73 or a pump that supplies the coolant of the first channel 71 to the cooling unit 73, and the cooler may be a water-cooled cooler.

When the cooling fluid is the refrigerant, the cooler 7 may supply the refrigerant to the second channel 72 by the cooling unit 73 and also may supply the refrigerant in the first channel 71 to the cooling unit 73, and the cooler may be a refrigerant-cooled cooler.

In the cooler 7, the cooling unit 73 may cool the cooling fluid that directly cools the cooling fluid and also may cool the cooling fluid through an intermediate heat exchanger. When the cooler 7 comprises the intermediate heat exchanger, the cooler 7 may further comprise a refrigeration cycle connected to the intermediate heat exchanger. The cooling fluid may be circulated through the outer flow path OP, the inner flow path IP, the first channel 71, the intermediate heat exchanger, and the second channel 72, the refrigerant may be circulated through the refrigeration cycle and the intermediate heat exchanger, and the intermediate heat exchanger may be heat-exchanged with the cooling fluid through the refrigerant.

The one ends 11 and 21 of the plurality of cables 1 and 2 may be connected to the power supply 8.

A portion including the one end of the plurality of cables 1 and 2 may extend into the power supply 8.

The power supply 8 may be provided with a pair of power terminals. The one ends 11 and 21 of the pair of cables 1 and 2 may be connected to each of the pair of power terminals, respectively.

The connector 9 may be connected to the other ends 12 and 22 of the plurality of cables 1 and 2. An example of the connector 9 may comprise a charging gun 92 that is connected to a vehicle's charging port. The charging gun 92 may be provided with a pair of charging terminals 94.

A portion including the other ends 12 and 22 of the plurality of cables 1 and 2 may extend into the connector 9. The other ends 12 and 22 of the plurality of cables 1 and 2 may be connected to the pair of charging terminals 94.

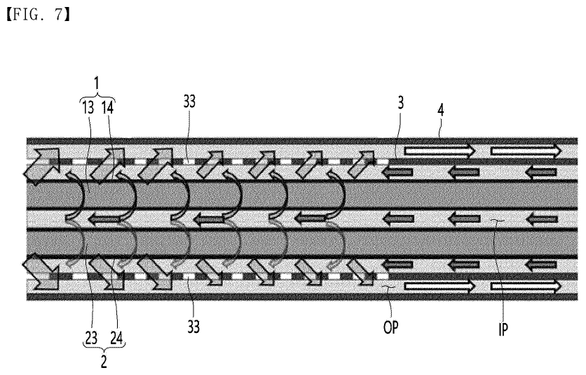

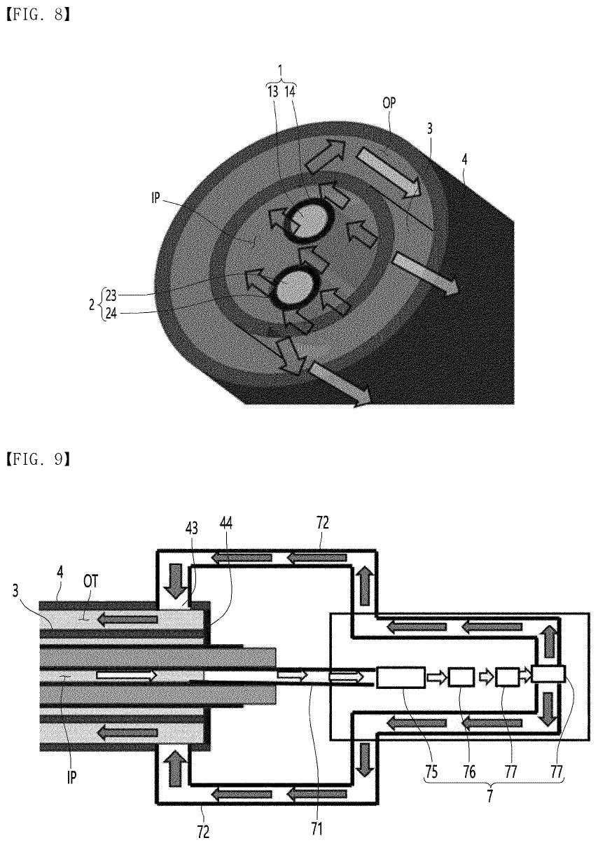

FIG. 7 is an enlarged view illustrating a flow of a cooling fluid inside an outer jacket as another example of the vehicle charging system according to this embodiment, and FIG. 8 is a cutaway view illustrating the flow of the cooling fluid as another example of the vehicle charging system according to this embodiment.

In another example of the vehicle charging system, the cooling fluid may pass through the inner flow path IP and then flow into the outer flow path OP.

The first channel 71 may be connected to the outer flow path OP, and the second channel 72 may be connected to the inner flow path IP. The first channel 71 may be connected to the outer hole 43 of the outer tube 4, and the second channel 72 may be connected to the through-hole of the cover 44.

In another example of the vehicle charging system, other configurations and operations other than the flow direction of the cooling fluid may be the same or similar to the example of the vehicle charging system, and thus, description thereof omitted to avoid duplicate description.

The cooling fluid may pass through the inner flow path IP and then pass through the outer flow path OP. Thereafter, after passing through the first channel 71, the cooling fluid may be cooled by the cooling unit 73, and the cooling fluid cooled by the unit 73 may pass through the second channel 72 to flow into the inner flow path IP. The cooling fluid may be circulated through the cooling unit 73, the second channel 72, the inner flow path IP, the outer flow path OP, and the first channel 71.

The cooling fluid cooled by the cooler 7 may first cool the inner flow path IP and then cool the outer flow path OP.

FIG. 9 is a view illustrating a flow of a refrigerant as further another example of the vehicle charging system according to this embodiment.

In further another example of the vehicle charging system, the cooling fluid may be a refrigerant, and the cooler may comprise a refrigeration cycle that is capable of cooling the refrigerant. An example of the refrigerant may comprise freon, ammonia, hydrocarbons, etc.

The cooler 7 may comprise a compressor 75, a condenser 76, an expander 77, and an evaporator 78, and also, the cooler may comprise a compressor 75, a condenser 76, an expander 77, and an evaporator 78, through which the cooling fluid, i.e., the refrigerant sequentially passes.

The first channel 71 may be connected to the compressor 75 to guide the refrigerant to the compressor 75.

The compressor 75 may be connected to the condenser 76 through an outlet pipe of the compressor.

The condenser 76 may be connected to the expander 77 through an outlet pipe of the condenser, and the expander 77 may be connected to the evaporator 78 through an inlet pipe of the evaporator.

The second channel 72 may be connected to the evaporator 78, and the refrigerant cooled in the evaporator 78 may be guided to the second channel 72.

The refrigerant may be circulated through the outer flow path OP, the inner flow path IP, the first channel 71, the compressor 75, the condenser 76, the expander 77, the evaporator 78, and the second channel 72 or may be calculated through the inner flow path IP, the outer flow path OP, the first channel 71, the compressor 75, the condenser 76, the expander 77, the evaporator 78, and the second channel 72.

Further another example of the vehicle charging system may have the same configuration and operation as those of the example of the vehicle charging system except that the first channel 71 is connected to the compressor 75, and the second channel 72 is connected to the evaporator 77, and thus, their descriptions will be omitted to avoid redundant explanations.

The above-disclosed subject matter is to be considered illustrative, and not restrictive, and the appended claims are intended to cover all such modifications, enhancements, and other embodiments, which fall within the true spirit and scope of the present disclosure.

Thus, the embodiment of the present disclosure is to be considered illustrative, and not restrictive, and the technical spirit of the present disclosure is not limited to the foregoing embodiment.

Therefore, the scope of the present disclosure is defined not by the detailed description of the invention but by the appended claims, and all differences within the scope will be construed as being comprised in the present disclosure.

1. A vehicle charging system comprising:
a plurality of cables;
an inner jacket in which an inner flow path is provided, wherein the plurality of cables pass through the inner flow path;
an outer jacket in which an outer flow path is provided and which is configured to surround an outer circumference of the inner jacket;
a porous material disposed in at least one of the inner flow path or the outer flow path; and
a cooler configured to cool a cooling fluid passing through one of the inner flow path and the outer flow path and supplies the cooling fluid to the other of the inner flow path and the outer flow path,
the vehicle charging system further comprising;
a power supply, to which one end of each of the plurality of cables is connected, and
a connector, to which the other end of each of the plurality of cables is connected,
wherein one end of the inner jacket is closer to the power supply of the power supply and the connector, and the other end of the inner jacket is closer to the connector of the power supply and the connector,
wherein the outer jacket comprises an outer through-hole that is closer to one end of the one end and the other end thereof, and
wherein the inner jacket comprises an inner through-hole that is closer to the other end of one end and the other end thereof.

2. The vehicle charging system according to claim 1, wherein the porous material comprises an inner porous material disposed between the plurality of cables and the inner jacket and configured to support the plurality of cables to be spaced apart from each other.

3. The vehicle charging system according to claim 1, wherein the porous material comprises an outer porous material disposed between the inner jacket and the outer jacket.

4. The vehicle charging system according to claim 1, wherein the porous material comprises metallic foam having porosity of 10% to 90%.

5. The vehicle charging system according to claim 1, wherein the porous material comprises metallic foam having thermal conductivity of 25 W/m·K to 35 W/m·K.

6. The vehicle charging system according to claim 1,
wherein the cooler is disposed inside the power supply.

7. The vehicle charging system according to claim 1, wherein the cooler comprises:
a first channel configured to guide the cooling fluid passing through one of the inner flow path and the outer flow path;
a cooling unit connected to the first channel to cool the cooling fluid guided to the first channel; and
a second channel configured to guide the cooling fluid cooled by the cooling unit to the other of the inner flow path and the outer flow path.

8. (canceled)

9. The vehicle charging system according to claim 1, wherein the inner through-hole is provided in plurality, and
the plurality of inner through-holes are arranged in a line in a longitudinal direction of the inner jacket.

10. The vehicle charging system according to claim 1, wherein the inner through-hole is provided in plurality, and
the plurality of inner through-holes are spaced apart from each other in a circumferential direction of the inner jacket.

11. The vehicle charging system according to claim 1, wherein the cooler comprises a thermoelectric element having a cooling body configured to cool the cooling fluid.

12. The vehicle charging system according to claim 1, wherein the cooler comprises a compressor, a condenser, an expander, and an evaporator, through which the cooling fluid sequentially passes.
